(19) United States
(12) Patent Application Publication
(10) Pub. No.: US 2024/0406982 A1
(43) Pub. Date: Dec. 5, 2024

(54) CONTENTION WINDOW SIZE ADJUSTMENT PROCEDURE FOR SIDELINK GROUPCAST

(71) Applicant: Lenovo (Singapore) Pte. Ltd., New Tech Park (SG)

(72) Inventors: Karthikeyan Ganesan, Kronberg im Taunus (DE); Ankit Bhamri, Rödermark (DE); Alexander Golitschek Edler von Elbwart, Darmstadt (DE); Vijay Nangia, Woodridge, IL (US); Ali Ramadan Ali, Kraiburg am Inn (DE); Ravi Kuchibhotla, Chicago, IL (US)

(21) Appl. No.: 18/697,098

(22) PCT Filed: Sep. 29, 2022
(86) PCT No.: PCT/IB2022/059315

§ 371 Date: Mar. 29, 2024

Related U.S. Application Data
(60) Provisional application No. 63/249,758, filed on Sep. 29, 2021.

(51) Int. Cl. H04W 72/40; H04L 1/1812; H04W 72/0446; H04W 74/08; H04W 74/0808

(52) U.S. Cl. CPC H04W 72/40; H04L 1/1812; H04W 72/0446; H04W 74/0808; H04W 74/0875

(57) ABSTRACT

Apparatuses, methods, and systems are disclosed for contention window size adjustment procedure for sidelink groupcast. An apparatus (500) includes a processor (505) and memory (510). The processor (505) is configured to transmit physical shared control channel (“PSCCH”) and physical shared sidelink channel (“PSSCH”) corresponding to groupcast data transmission. The processor (505) is configured to receive physical shared feedback channel (“PSFCH”) containing hybrid automatic repeat request (“HARQ”) feedback after a predetermined number of slots for a corresponding groupcast transmission. The processor (505) is configured to determine a contention window size adjustment for a groupcast PSSCH based on the transmitted groupcast HARQ feedback associated with PSSCH within a reference duration.

### CROSS-REFERENCE TO RELATED APPLICATIONS

This application claims the benefit of U.S. Provisional Patent Application No. 63/249,758, entitled “CONTENTION WINDOW SIZE ADJUSTMENT PROCEDURE FOR SIDELINK GROUPCAST” and filed on Sep. 29, 2021, for Karthikeyan Ganesan, et al., which is incorporated herein by reference.

### FIELD

The subject matter disclosed herein relates generally to wireless communications and more particularly relates to contention window size adjustment procedure for sidelink groupcast.

### BACKGROUND

In wireless networks, devices may connect directly to one another using a technique called sidelink communications. Sidelink is a communication paradigm in which cellular devices are able to communicate without relaying their data via the network.

### BRIEF SUMMARY

Apparatuses, methods, and systems are disclosed for contention window size adjustment procedure for sidelink groupcast.

In one embodiment, a first apparatus includes a processor and a memory coupled to the processor. In one embodiment, the processor is configured to cause the apparatus to transmit physical shared control channel (“PSCCH”) and physical shared sidelink channel (“PSSCH”) corresponding to groupcast data transmission. In one embodiment, the processor is configured to cause the apparatus to receive physical shared feedback channel (“PSFCH”) containing hybrid automatic repeat request (“HARQ”) feedback after a predetermined number of slots for a corresponding groupcast transmission. In one embodiment, the processor is configured to cause the apparatus to determine a contention window size adjustment for a groupcast PSSCH based on the transmitted groupcast HARQ feedback associated with PSSCH within a reference duration.

In one embodiment, a first method transmits PSCCH and PSSCH corresponding to groupcast data transmission. In one embodiment, the first method receives PSFCH containing HARQ feedback after a predetermined number of slots for a corresponding groupcast transmission. In one embodiment, the first method determines a contention window size adjustment for a groupcast PSSCH based on the transmitted groupcast HARQ feedback associated with PSSCH within a reference duration.

In one embodiment, a second apparatus includes a processor and a memory coupled to the processor. In one embodiment, the processor is configured to cause the apparatus to receive PSCCH and PSSCH corresponding to groupcast data transmission. In one embodiment, the processor is configured to cause the apparatus to transmit PSFCH containing HARQ feedback after a predetermined number of slots for a corresponding groupcast transmission for determining a contention window size adjustment for a groupcast PSSCH based on the transmitted groupcast HARQ feedback associated with PSSCH within a reference duration.

In one embodiment, a second method receives PSCCH and PSSCH corresponding to groupcast data transmission. In one embodiment, the second method transmits PSFCH containing HARQ feedback after a predetermined number of slots for a corresponding groupcast transmission for determining a contention window size adjustment for a groupcast PSSCH based on the transmitted groupcast HARQ feedback associated with PSSCH within a reference duration.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for contention window size adjustment procedure for sidelink groupcast;

FIG. 2 depicts an example of channel access in new radio (“NR”)-U;

FIG. 3 depicts a user equipment (“UE”)-to-UE relay;

FIG. 4 is a diagram illustrating one embodiment of a NR protocol stack;

FIG. 5 is a block diagram illustrating one embodiment of a user equipment apparatus that may be used for contention window size adjustment procedure for sidelink groupcast;

FIG. 6 is a block diagram illustrating one embodiment of a network apparatus that may be used for contention window size adjustment procedure for sidelink groupcast;

FIG. 7 is a flowchart diagram illustrating one embodiment of a method for contention window size adjustment procedure for sidelink groupcast; and

FIG. 8 is a flowchart diagram illustrating one embodiment of a method for contention window size adjustment procedure for sidelink groupcast.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatuses for contention window size adjustment procedure for sidelink groupcast. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

The type-1 channel access describing contention window size adaptation procedure described in 3GPP TS 37.213 (which is incorporated herein by reference) is for Uu interface and more specifically designed for unicast physical downlink shared channel (“PDSCH”), physical uplink shared channel (“PUSCH”) and then transport block (“TB”) and code block group (“CBG”) based transmission. However, such a contention window size (“CWS”) adjustment procedure may need further consideration for groupcast or multicast traffic considering different HARQ feedback types of support for groupcast e.g., Groupcast HARQ feedback option 1 (common NACK), Groupcast HARQ feedback option 2 (dedicated ACK/NACK) defined in NR Rel16 Sidelink.

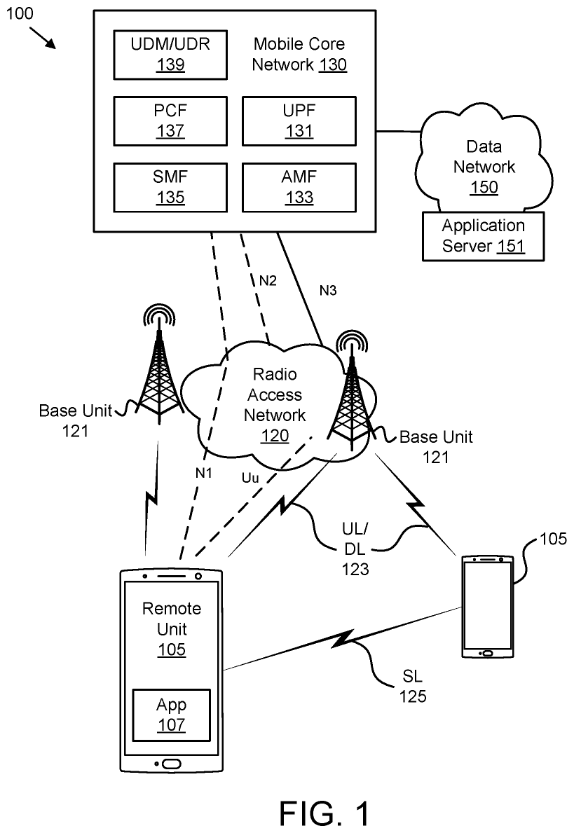

FIG. 1 depicts a wireless communication system 100 supporting CSI enhancements for higher frequencies, according to embodiments of the disclosure. In one embodiment, the wireless communication system 100 includes at least one remote unit 105, a radio access network (“RAN”) 120, and a mobile core network 130. The RAN 120 and the mobile core network 130 form a mobile communication network. The RAN 120 may be composed of a base unit 121 with which the remote unit 105 communicates using wireless communication links 115. Even though a specific number of remote units 105, base units 121, wireless communication links 115, RANs 120, and mobile core networks 130 are depicted in FIG. 1, one of skill in the art will recognize that any number of remote units 105, base units 121, wireless communication links 115, RANs 120, and mobile core networks 130 may be included in the wireless communication system 100.

In one implementation, the RAN 120 is compliant with the 5G system specified in the Third Generation Partnership Project (“3GPP”) specifications. For example, the RAN 120 may be a New Generation Radio Access Network (“NG-RAN”), implementing NR RAT and/or 3GPP Long-Term Evolution (“LTE”) RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base units 121 in the RAN 120 via uplink (“UL”) and downlink (“DL”) communication signals. Furthermore, the UL and DL communication signals may be carried over the wireless communication links 123. Here, the RAN 120 is an intermediate network that provides the remote units 105 with access to the mobile core network 130.

In some embodiments, the remote units 105 communicate with an application server via a network connection with the mobile core network 130. For example, an application 107 (e.g., web browser, media client, telephone and/or Voice-over-Internet-Protocol (“VoIP”) application) in a remote unit 105 may trigger the remote unit 105 to establish a protocol data unit (“PDU”) session (or other data connection) with the mobile core network 130 via the RAN 120. The mobile core network 130 then relays traffic between the remote unit 105 and the application server (e.g., the content server 151 in the packet data network 150) using the PDU session. The PDU session represents a logical connection between the remote unit 105 and the User Plane Function (“UPF”) 131.

In order to establish the PDU session (or PDN connection), the remote unit 105 must be registered with the mobile core network 130 (also referred to as “attached to the mobile core network” in the context of a Fourth Generation (“4G”) system). Note that the remote unit 105 may establish one or more PDU sessions (or other data connections) with the mobile core network 130. As such, the remote unit 105 may have at least one PDU session for communicating with the packet data network 150, e.g., representative of the Internet. The remote unit 105 may establish additional PDU sessions for communicating with other data networks and/or other communication peers.

In the context of a 5G system (“5GS”), the term “PDU Session” a data connection that provides end-to-end (“E2E”) user plane (“UP”) connectivity between the remote unit 105 and a specific Data Network (“DN”) through the UPF 131. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QOS Identifier (“5QI”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a Packet Gateway (“PGW”, not shown) in the mobile core network 130. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 130 via the RAN 120.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121. Note that during NR-U operation, the base unit 121 and the remote unit 105 communicate over unlicensed radio spectrum.

In one embodiment, the sidelink 125 connection enables direct communication between two devices without the participation of a base station in the transmission and reception of data traffic.

In one embodiment, the mobile core network 130 is a 5GC or an Evolved Packet Core (“EPC”), which may be coupled to a packet data network 150, like the Internet and private data networks, among other data networks. A remote unit 105 may have a subscription or other account with the mobile core network 130. Each mobile core network 130 belongs to a single public land mobile network (“PLMN”). The present disclosure is not intended to be limited to the implementation of any particular wireless communication system architecture or protocol.

The mobile core network 130 includes several network functions (“NFs”). As depicted, the mobile core network 130 includes at least one UPF 131. The mobile core network 130 also includes multiple control plane (“CP”) functions including, but not limited to, an Access and Mobility Management Function (“AMF”) 133 that serves the RAN 120, a Session Management Function (“SMF”) 135, a Network Exposure Function (“NEF”), a Policy Control Function (“PCF”) 137, a Unified Data Management function (“UDM”) and a User Data Repository (“UDR”).

The UPF(s) 131 is responsible for packet routing and forwarding, packet inspection, QoS handling, and external PDU session for interconnecting Data Network (“DN”), in the 5G architecture. The AMF 133 is responsible for termination of NAS signaling, NAS ciphering & integrity protection, registration management, connection management, mobility management, access authentication and authorization, security context management. The SMF 135 is responsible for session management (i.e., session establishment, modification, release), remote unit (i.e., UE) IP address allocation & management, DL data notification, and traffic steering configuration for UPF for proper traffic routing.

The NEF is responsible for making network data and resources easily accessible to customers and network partners. Service providers may activate new capabilities and expose them through APIs. These APIs allow third-party authorized applications to monitor and configure the network's behavior for a number of different subscribers (i.e., connected devices with different applications). The PCF 137 is responsible for unified policy framework, providing policy rules to CP functions, access subscription information for policy decisions in UDR.

The UDM is responsible for generation of Authentication and Key Agreement (“AKA”) credentials, user identification handling, access authorization, subscription management. The UDR is a repository of subscriber information and can be used to service a number of network functions. For example, the UDR may store subscription data, policy-related data, subscriber-related data that is permitted to be exposed to third party applications, and the like. In some embodiments, the UDM is co-located with the UDR, depicted as combined entity “UDM/UDR” 139.

In various embodiments, the mobile core network 130 may also include an Authentication Server Function (“AUSF”) (which acts as an authentication server), a Network Repository Function (“NRF”) (which provides NF service registration and discovery, enabling NFs to identify appropriate services in one another and communicate with each other over Application Programming Interfaces (“APIs”)), or other NFs defined for the 5GC. In certain embodiments, the mobile core network 130 may include an authentication, authorization, and accounting (“AAA”) server.

In various embodiments, the mobile core network 130 supports different types of mobile data connections and different types of network slices, wherein each mobile data connection utilizes a specific network slice. Here, a “network slice” refers to a portion of the mobile core network 130 optimized for a certain traffic type or communication service. A network instance may be identified by a single-network slice selection assistance information (“S-NSSAI,”) while a set of network slices for which the remote unit 105 is authorized to use is identified by network slice selection assistance information (“NSSAI”).

Here, “NSSAI” refers to a vector value including one or more S-NSSAI values. In certain embodiments, the various network slices may include separate instances of network functions, such as the SMF 135 and UPF 131. In some embodiments, the different network slices may share some common network functions, such as the AMF 133. The different network slices are not shown in FIG. 1 for ease of illustration, but their support is assumed. Where different network slices are deployed, the mobile core network 130 may include a Network Slice Selection Function (“NSSF”) which is responsible for selecting of the Network Slice instances to serve the remote unit 105, determining the allowed NSSAI, determining the AMF set to be used to serve the remote unit 105.

Although specific numbers and types of network functions are depicted in FIG. 1, one of skill in the art will recognize that any number and type of network functions may be included in the mobile core network 130. Moreover, in an LTE variant where the mobile core network 130 comprises an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 133 may be mapped to an MME, the SMF 135 may be mapped to a control plane portion of a PGW and/or to an MME, the UPF 131 may be mapped to an SGW and a user plane portion of the PGW, the UDM/UDR 139 may be mapped to an HSS, etc.

While FIG. 1 depicts components of a 5G RAN and a 5G core network, the described embodiments apply to other types of communication networks and RATs, including IEEE 802.11 variants, Global System for Mobile Communications (“GSM”, i.e., a 2G digital cellular network), General Packet Radio Service (“GPRS”), UMTS, LTE variants, CDMA 2000, Bluetooth, ZigBee, Sigfox, and the like.

In the following descriptions, the term “gNB” is used for the base station but it is replaceable by any other radio access node, e.g., RAN node, eNB, Base Station (“BS”), Access Point (“AP”), NR, etc. Further the operations are described mainly in the context of 5G NR. However, the proposed solutions/methods are also equally applicable to other mobile communication systems supporting CSI enhancements for higher frequencies.

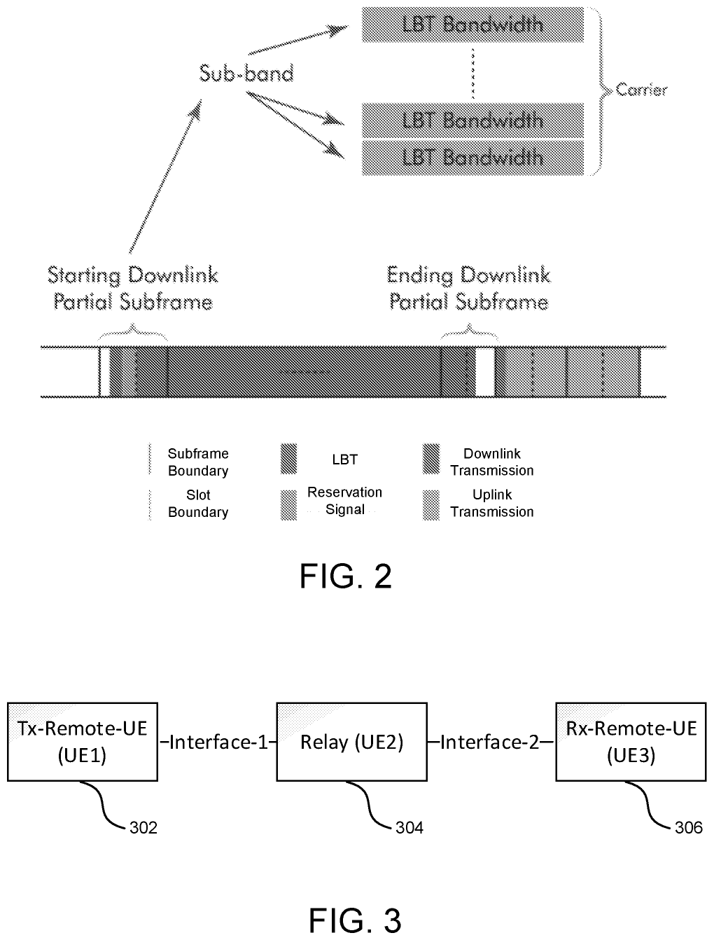

As background, in NR-U, channel access in both DL and UL rely on listen before talk (“LBT”). A gNB and/or UE first senses the channel to determine if there is no on-going communications prior to any transmission. When a communication channel is a wide bandwidth unlicensed carrier, the clear channel assessment (“CCA”) procedure relies on detecting the energy level on multiple sub-bands of the communications channel as shown in FIG. 2. No beamforming is considered for LBT in NR-U in Rel. 16 and only omni-directional LBT is assumed.

TABLE 1
Channel Access Priority Class (CAPC)

| Channel Access | | | | | | |
|---|---|---|---|---|---|---|
| Priority Class (p) | mₚ | CW_{min, p} | CW_{max, p} | T_{mcot, p} | | allowed CWₚsizes |
| 1 | 1 | 3 | 7 | 2 | ms | {3, 7} |
| 2 | 1 | 7 | 15 | 3 | ms | {7, 15} |
| 3 | 3 | 15 | 63 | 8 or 10 | ms | {15, 31, 63} |
| 4 | 7 | 15 | 1023 | 8 or 10 | ms | {15, 31, 63, 127, |
| | | | | | | 255, 511, 1023} |

In NR-U in Rel. 16, for CW adjustment for transmissions including PDSCH and PUSCH:
if new HARQ feedback is available relative to the prior CW update, the feedback for the latest COT for which new feedback is received shall be used.
if the HARQ feedback is ACK, CW shall be set to CWmin.
if the HARQ feedback is NACK (or if in absence of feedback within a window as defined below, the gNB or the UE retransmits the TB), CW shall be set to min (CW×2+1, CWmax).
   Window starts at the end of the reference duration and has a duration of max (X ms, the duration of the transmission burst from start of the reference duration+1 ms)
   If the absence of other technologies cannot be guaranteed (same condition as in existing specs for other cases), X=5. Otherwise, X=10.
Otherwise, if new HARQ feedback is not available, CW shall remain the same.
Note: HARQ feedback includes any implicit methods of HARQ feedback determination.

For TB based HARQ feedback within a single LBT subband, CW is reset if at least one “ACK” is received, or at least one NDI is toggled for the TB(s) transmitted in the reference duration. Note: HARQ feedback includes any implicit methods of HARQ feedback determination.

For CBG based HARQ feedback within a single LBT subband, and when all CBGs are confined within the LBT subband, CW is reset if “ACK” is received for at least 10% of the CBGs in the reference duration. For purpose of CWS adjustment, a CBG TI set to 0 is assumed to be an ACK. Note: HARQ feedback includes any implicit methods of HARQ feedback determination.

Channels without explicit feedback use the CWS last updated by channels with explicit feedback and using the same CAPC if such channels exist; otherwise they use the minimum CWS corresponding to the CAPC.

For CWS adjustment for an LBT sub-band when a single contention window is maintained per LBT subband, CBGs (if any are present) and TBs that partially or fully overlap with that LBT sub-band are taken into account. CW is reset if “ACK” is received for at least 10% of the CBGs or for at least one TB in the reference duration. Note: Other procedures for contention window adjustment within an LBT subband are also applicable. A UE can choose to apply feedback only based on TBs for CW adjustment

For CWS adjustment for DL, when a single contention window is maintained for multiple LBT subbands, CBGs (if any are present) and TBs that partially or fully overlap with those multiple LBT sub-bands are taken into account. CW is reset if “ACK” is received for at least 10% of the CBGs or for at least one TB in the reference duration. Note: Other procedures for contention window adjustment within an LBT subband are also applicable.

According to 3GPP TS 37.213 (incorporated herein by reference), contention window adjustment procedures, if an eNB/gNB transmits transmissions including PDSCH that are associated with channel access priority class p on a channel, the eNB/gNB maintains the contention window value CWₚ and adjusts CWₚ before step 1 of the procedure described in clause 4.1.1 for those transmissions as described in this clause.

If an eNB transmits transmissions including PDSCH that are associated with channel access priority class p on a channel, the eNB maintains the contention window value CWₚ and adjusts CWₚ before step 1 of the procedure described in clause 4.1.1 for those transmissions using the following steps:
for every priority class pϵ{1,2,3,4} set CWₚ=CW_{min,p}.
if at least Z=80% of HARQ-ACK values corresponding to PDSCH transmission(s) in reference subframe k are determined as NACK, increase CWₚ for every priority class pϵ{1,2,3,4} to the next higher allowed value and remain in step 2; otherwise, go to step 1.

Reference subframe k is the starting subframe of the most recent transmission on the channel made by the eNB, for which at least some HARQ-ACK feedback is expected to be available.

The eNB shall adjust the value of CWₚ for every priority class pϵ{1,2,3,4} based on a given reference subframe k only once.

For determining Z,
if the eNB transmission(s) for which HARQ-ACK feedback is available start in the second slot of subframe k, HARQ-ACK values corresponding to PDSCH transmission(s) in subframe k+1 are also used in addition to the HARQ-ACK values corresponding to PDSCH transmission(s) in subframe k.
if the HARQ-ACK values correspond to PDSCH transmission(s) on an LAA SCell that are assigned by (E) PDCCH transmitted on the same LAA SCell,
   if no HARQ-ACK feedback is detected for a PDSCH transmission by the eNB, or if the eNB detects ‘DTX’, ‘NACK/DTX’ or ‘any’ state, it is counted as NACK.
if the HARQ-ACK values correspond to PDSCH transmission(s) on an LAA SCell that are assigned by (E) PDCCH transmitted on another serving cell,
   if the HARQ-ACK feedback for a PDSCH transmission is detected by the eNB, ‘NACK/DTX’ or ‘any’ state is counted as NACK, and ‘DTX’ state is ignored.
   if no HARQ-ACK feedback is detected for a PDSCH transmission by the eNB
      if PUCCH format 1b with channel selection is expected to be used by the UE, ‘NACK/DTX’ state corresponding to ‘no transmission’ as described in Clauses 10.1.2.2.1, 10.1.3.1 and 10.1.3.2.1 is counted as NACK, and ‘DTX’ state corresponding to ‘no transmission’ is ignored.
      Otherwise, the HARQ-ACK for the PDSCH transmission is ignored.
if a PDSCH transmission has two codewords, the HARQ-ACK value of each codeword is considered separately.
bundled HARQ-ACK across M subframes is considered as M HARQ-ACK responses.

If the eNB transmits transmissions including PDCCH/EPDCCH with DCI format 0A/0B/4A/4B and not including PDSCH that are associated with channel access priority class p on a channel starting from time to, the eNB maintains the contention window value CWₚ and adjusts CWₚ before step 1 of the procedure described in clause 4.1.1 for those transmissions using the following steps:
for every priority class pϵ{1,2,3,4} set CWₚ=CW_{min,p}
if less than 10% of the UL transport blocks scheduled by the eNB using Type 2 channel access procedure (described in clause 4.2.1.2) in the time interval between t₀ and t₀+T_{CO} have been received successfully, increase CWₚ for every priority class pϵ{1,2,3,4} to the next higher allowed value and remain in step 2; otherwise, go to step 1.

T_{CO} is computed as described in clause 4.2.1.0.3.

If a gNB transmits transmissions including PDSCH that are associated with channel access priority class p on a channel, the gNB maintains the contention window value CWₚ and adjusts CWₚ before step 1 of the procedure described in clause 4.1.1 for those transmissions using the following steps:
1) For every priority class pϵ{1,2,3,4}, set CWₚ=CW_{min,p}.
2) If HARQ-ACK feedback is available after the last update of CWₚ, go to step 3. Otherwise, if the gNB transmission after procedure described in clause 4.1.1 does not include a retransmission or is transmitted within a duration T_{w} from the end of the reference duration corresponding to the earliest DL channel occupancy after the last update of CWₚ, go to step 5; otherwise go to step 4.
3) The HARQ-ACK feedback(s) corresponding to PDSCH(s) in the reference duration for the latest DL channel occupancy for which HARQ-ACK feedback is available is used as follows:
   a. If at least one HARQ-ACK feedback is ‘ACK’ for PDSCH(s) with transport block based feedback or at least 10% of HARQ-ACK feedbacks is ‘ACK’ for PDSCH CBGs transmitted at least partially on the channel with code block group based feedback, go to step 1; otherwise go to step 4.
4) Increase CWₚ for every priority class pϵ{1,2,3,4} to the next higher allowed value.
5) For every priority class pϵ{1,2,3,4}, maintain CWₚ as it is; go to step 2.

The reference duration and duration T_{w} in the procedure above are defined as follows:
The reference duration corresponding to a channel occupancy initiated by the gNB including transmission of PDSCH(s) is defined in this clause as a duration starting from the beginning of the channel occupancy until the end of the first slot where at least one unicast PDSCH is transmitted over all the resources allocated for the PDSCH, or until the end of the first transmission burst by the gNB that contains unicast PDSCH(s) transmitted over all the resources allocated for the PDSCH, whichever occurs earlier. If the channel occupancy includes a unicast PDSCH, but it does not include any unicast PDSCH transmitted over all the resources allocated for that PDSCH, then, the duration of the first transmission burst by the gNB within the channel occupancy that contains unicast PDSCH(s) is the reference duration for CWS adjustment.
T_{w}=max (T_{A},T_{B}+1 ms) where T_{B} is the duration of the transmission burst from start of the reference duration in ms and T_{A}=5 ms if the absence of any other technology sharing the channel cannot be guaranteed on a long-term basis (e.g. by level of regulation), and T_{A}=10 ms otherwise.

If a gNB transmits transmissions using Type 1 channel access procedures associated with the channel access priority class p on a channel and the transmissions are not associated with explicit HARQ-ACK feedbacks by the corresponding UE(s), the gNB adjusts CWₚ before step 1 in the procedures described in subclause 4.1.1, using the latest CWₚ used for any DL transmissions on the channel using Type 1 channel access procedures associated with the channel access priority class p. If the corresponding channel access priority class p has not been used for any DL transmissions on the channel, CWₚ=CW_{min,p} is used.

If a UE transmits transmissions using Type 1 channel access procedures that are associated with channel access priority class p on a channel, the UE maintains the contention window value CWₚ and adjusts CWₚ for those transmissions before step 1 of the procedure described in subclause 4.2.1.1, using the following procedure:
If the UE receives an UL grant or an AUL-DFI, the contention window size for all the priority classes is adjusted as following:
   If the NDI value for at least one HARQ process associated with HARQ_ID_ref is toggled, or if the HARQ-ACK value(s) for at least one of the HARQ processes associated with HARQ_ID_ref received in the earliest AUL-DFI after n_{ref}+3 indicates ACK,
      for every priority class pϵ{1,2,3,4}, set CWₚ=CW_{min,p};
   Otherwise, increase CWₚ for every priority class pϵ{1,2,3,4} to the next higher allowed value;
If there exists one or more previous transmissions {T₀, . . . , Tₙ} using Type 1 channel access procedure, from the start subframe(s) of the previous transmission(s) of which, N or more subframes have elapsed and neither UL grant nor AUL-DFI was received, where N=max (contentionWindowSizeTimer, Tᵢ burst length+1) if contentionWindowSizeTimer>0 and N=0 otherwise, for each transmission Tᵢ, CWₚ is adjusted as following:
   increase CWₚ for every priority class pϵ{1,2,3,4} to the next higher allowed value;
   The CWₚ is adjusted once
Else if the UE transmits transmissions using Type 1 channel access procedure before N subframes have elapsed from the start of previous UL transmission burst using Type 1 channel access procedure and neither UL grant nor AUL-DFI is received,
   the CWₚ is unchanged.
If the UE receives an UL grant or an AUL-DFI indicates feedback for one or more previous transmissions {T₀, . . . , Tₙ} using Type 1 channel access procedure, from the start subframe(s) of the previous transmission(s) of which, N or more subframes have elapsed and neither UL grant nor AUL-DFI was received, where N=max (contentionWindowSizeTimer, Tᵢ burst length+1) if contentionWindowSizeTimer>0 and N=0 otherwise, the UE may recompute CWₚ as follows:
   The UE reverts CWₚ to the value used to transmit at n_{T0} using Type 1 channel access procedure.
   The UE updates CWₚ sequentially in the order of the transmission {T₀, . . . , Tₙ}
      If the NDI value for at least one HARQ process associated with HARQ_ID_ref is toggled, or if the HARQ-ACK value(s) for at least one of the HARQ processes associated with HARQ_ID_ref received in the earliest AUL-DFI after n_{Ti}+3 indicates ACK,
         for every priority class pϵ{1,2,3,4} set CWₚ=CW_{min,p}.
      Otherwise, increase CWₚ for every priority class pϵ{1,2,3,4} to the next higher allowed value.
If the UE transmits transmissions using Type 1 channel access procedure before N subframes have elapsed from the start of previous UL transmission burst using Type 1 channel access procedure and neither UL grant nor AUL-DFI is received,
   CWₚ is unchanged.

HARQ_ID_ref is the HARQ process ID of UL-SCH in reference subframe n_{ref}. The reference subframe n_{ref} is determined as follows.
If the UE receives an UL grant or an AUL-DFI in subframe n_{g}, subframe n_{w} is the most recent subframe before subframe n_{g}−3 in which the UE has transmitted UL-SCH using Type 1 channel access procedure.
   If the UE transmits transmissions including UL-SCH without gaps starting with subframe no and in subframes n₀, n₁, . . . , n_{w} and the UL-SCH in subframe n₀ is not PUSCH Mode 1 that starts in the second slot of the subframe, reference subframe n_{ref} is subframe n₀.
   If the UE transmits transmissions including PUSCH Mode 1 without gaps starting with second slot of subframe n₀ and in subframes n₀, n₁, . . . , n_{w} and the, reference subframe n_{ref} is subframe n₀ and n₁,
   otherwise, reference subframe n_{ref} is subframe n_{w}.

HARQ_ID_ref is the HARQ process ID of UL-SCH in reference subframe n_{Ti}. The reference subframe n_{Ti} is determined as the start subframe of a transmission Tᵢ using Type 1 channel access procedure and of which, N subframes have elapsed and neither UL grant nor AUL-DFI was received.

If the AUL-DFI with DCI format 0A is indicated to a UE that is activated with AUL transmission and transmission mode 2 is configured for the UE for grant-based uplink transmissions, the spatial HARQ-ACK bundling shall be performed by logical OR operation across multiple codewords for the HARQ process not configured for autonomous UL transmission.

If CWₚ changes during an ongoing channel access procedure, the UE shall draw a counter Nᵢₙᵢₜ and applies it to the ongoing channel access procedure.

The UE may keep the value of CWₚ unchanged for every priority class p E {1,2,3,4}, if the UE scheduled to transmit transmissions without gaps including PUSCH in a set subframes n₀, n₁, . . . , n_{w-1} using Type 1 channel access procedure, and if the UE is not able to transmit any transmission including PUSCH in the set of subframes.

The UE may keep the value of CWₚ for every priority class pϵ{1,2,3,4} the same as that for the last scheduled transmission including PUSCH using Type 1 channel access procedure, if the reference subframe for the last scheduled transmission is also n_{ref}.

If a UE transmits transmissions using Type 1 channel access procedures that are associated with channel access priority class p on a channel, the UE maintains the contention window value CWₚ and adjusts CWₚ for those transmissions before step 1 of the procedure described in subclause 4.2.1.1, using the following steps:
1) For every priority class pϵ{1,2,3,4}, set CWₚ=CW_{min,p};
2) If HARQ-ACK feedback is available after the last update of CWₚ, go to step 3. Otherwise, if the UE transmission after procedure described in subclause 4.2.1.1 does not include a retransmission or is transmitted within a duration T_{w} from the end of the reference duration corresponding to the earliest UL transmission burst after the last update of CWₚ transmitted after the procedures described in subclause 4.1.1, go to step 5; otherwise go to step 4.
3) The HARQ-ACK feedback(s) corresponding to PUSCH(s) in the reference duration for the latest UL transmission burst for which HARQ-ACK feedback is available is used as follows:
   a. If at least one HARQ-ACK feedback is ‘ACK’ for PUSCH(s) with transport block (TB) based transmissions or at least 10% of HARQ-ACK feedbacks is ‘ACK’ for PUSCH(s) with code block group (CBG) based transmissions go to step 1; otherwise go to step 4.
4) Increase CWₚ for every priority class pϵ{1,2,3,4} to the next higher allowed value;
5) For every priority class pϵ{1,2,3,4}, maintain CWₚ as it is; go to step 2.

The HARQ-ACK feedback, reference duration and duration T_{w} in the procedure above are defined as the following:
HARQ-ACK feedback for PUSCH(s) transmissions are expected to be provided to UE(s) explicitly or implicitly where implicit HARQ-ACK feedback for the purpose of contention window adjustment in this subclause, is determined based on the indication for a new transmission or retransmission in the DCI scheduling PUSCH(s) as follows:
   If a new transmission is indicated, ‘ACK’ is assumed for the transport blocks or code block groups in the corresponding PUSCH(s) for the TB-based and CBG-based transmission, respectively.
   If a retransmission is indicated for TB-based transmissions, ‘NACK’ is assumed for the transport blocks in the corresponding PUSCH(s).
   If a retransmission is indicated for CBG-based transmissions, if a bit value in the code block group transmission information (CBGTI) field is ‘0’ or ‘1’, ‘ACK’ or ‘NACK’ is assumed for the corresponding CBG in the corresponding PUSCH(s), respectively.
The reference duration corresponding to a channel occupancy initiated by the UE including transmission of PUSCH(s) is defined in this subclause as a duration starting from the beginning of the channel occupancy until the end of the first slot where at least one unicast PUSCH is transmitted over all the resources allocated for the PUSCH, or until the end of the first transmission burst by the gNB that contains unicast PUSCH(s) transmitted over all the resources allocated for the PDSCH, whichever occurs earlier. If the channel occupancy includes a unicast PDSCH, but it does not include any unicast PDSCH transmitted over all the resources allocated for that PUSCH, then, the duration of the first transmission burst by the UE within the channel occupancy that contains PUSCH(s) is the reference duration for CWS adjustment.
T_{w}=max (T_{A},T_{B}+1 ms) where T_{B} is the duraon of the transmission burst from start of the reference duration in ms and T_{A}=5 ms if the absence of any other technology sharing the channel cannot be guaranteed on a long-term basis (e.g. by level of regulation), and T_{A}=10 ms otherwise.

If a UE transmits transmissions using Type 1 channel access procedures associated with the channel access priority class p on a channel and the transmissions are not associated with explicit or implicit HARQ-ACK feedbacks as described above in this subclause, the UE adjusts CWₚ before step 1 in the procedures described in subclause 4.2.1.1, using the latest CWₚ used for any UL transmissions on the channel using Type 1 channel access procedures associated with the channel access priority class p. If the corresponding channel access priority class p has not been for any UL transmission on the channel, CWₚ=CW_{min,p} is used.

In general, the subject matter described herein is directed to a sidelink channel access procedure for CWS adjustment for groupcast data transmission containing different SL groupcast HARQ feedback options:
CWS adjustment for groupcast HARQ feedback option 1 involves NACK feedback received from the group member UEs within the reference duration is taken into consideration for the CWS adjustment procedure.
CWS adjustment for the groupcast HARQ feedback option 2 involves number of NACK feedback received from the group member UEs within the reference duration is taken into consideration for the CWS adjustment procedure.
The various definition of the reference duration for PSSCH considering groupcast is proposed.

In a first embodiment directed to CWS adjustment for groupcast HARQ feedback option 2 (dedicated ACK/NACK), the determination of the CWS adjustment for sidelink groupcast based PSSCH transmission could be based on the configured/signaled sidelink groupcast HARQ feedback option-2, where a transmitting (“Tx”) UE could be transmitting PSSCH using sidelink groupcast HARQ feedback option-2 by transmitting SCI format 2A with cast type indicator set to ‘01’.

CWS adjustment procedure for the groupcast HARQ feedback option-2 involves a number of ACK or NACK feedbacks received from one or more group member UEs within the reference duration, where the reference duration corresponds to a channel occupancy initiated by a Tx UE including transmission of groupcast PSSCH (associated with a groupcast HARQ feedback option-2), as a duration starting from the beginning of the channel occupancy until the end of the first slot where at least one groupcast PSSCH (associated with a groupcast HARQ feedback option-2) is transmitted over all the resources allocated for the groupcast PSSCH, or until the end of the first transmission burst by the Tx UE that contains groupcast PSSCH(s) (associated with a groupcast HARQ feedback option-2) transmitted over all the resources allocated for the groupcast PSSCH, whichever occurs earlier. If the channel occupancy includes a groupcast PSSCH (associated with a groupcast HARQ feedback option-2), but it does not include any groupcast PSSCH (associated with a groupcast HARQ feedback option-2) transmitted over the resources allocated for that groupcast PSSCH, then, the duration of the first transmission burst by the UE within the channel occupancy that contains groupcast PSSCH(s) (associated with a groupcast HARQ feedback option-2) is the reference duration for CWS adjustment.

Another example for a reference duration corresponds to a channel occupancy initiated by a Tx UE including transmission of groupcast PSSCH (associated with a groupcast HARQ feedback option-2), as a duration starting from the beginning of the channel occupancy until at least HARQ-ACK feedback is expected or received from at least one PSFCH reception occasion among the number of PSFCH reception occasions in PSFCH resources (associated with the groupcast PSSCH) from one or more group member UEs belonging to same L2 destination ID.

In one embodiment, for every channel access priority class pϵ{1,2,3,4} set CWp=CWmin,p. If the UE receives a PSFCH associated with a groupcast HARQ feedback option-2, and if at least Z=X % of HARQ-ACK feedback values determined as ‘NACK’ corresponding to the groupcast PSSCH transmission within the reference duration from at least one PSFCH reception occasion from the number of PSFCH reception occasions in PSFCH resources corresponding to every identity M_“ID” of UEs that the UE expects to receive corresponding PSSCHs, increase the CWS for every priority class to the next higher allowed value or min (CWp×2+1, CWmax,p).

Otherwise, if at least Z=Y % of HARQ-ACK feedback values determined as ‘ACK’ corresponding to groupcast PSSCH transmission within the reference duration corresponding to every identity M_“ID” of UEs that the UE expects to receive corresponding PSSCHs, then CWS is set to CWmin,p (go to step 1 as described in the first bullet (e.g., step 1 as described in TS 37.213)).

If no HARQ-ACK feedback(s) is detected for a groupcast PSSCH transmission corresponding to every identity M_“ID” of UEs that the UE expects to receive corresponding PSSCHs belonging to the same L2 destination id, or if the Tx UE detects ‘DTX’, then it is counted as NACK corresponding to the identity M_“ID” of the receiving (“Rx”) UE. Follow the above step if at least Z=X % of HARQ-ACK values determined as ‘NACK’ from one or more group member UEs belonging to same L2 destination ID.

The value of Z=X % and/or Z=Y % of NACK and/or ACK respectively could be configured per resource pool or per UE or destination group or carrier or fixed value specified in the standard. These values may depend on the number of UEs sending PSFCH feedback corresponding to groupcast PSSCH transmission.

In a second embodiment directed to CWS adjustment for groupcast HARQ feedback option 1 (common NACK feedback resource), the determination of the contention window size (CWS) adjustment for sidelink groupcast based PSSCH transmission could be based on the configured/signaled sidelink groupcast HARQ feedback option-1, where the UE could be configured with sidelink groupcast HARQ feedback option-1 using one of the following methods, if the UE is configured to transmit SCI format 2B or SCI format 2A with cast type indicator set to ‘11’.

In the first implementation, CWS adjustment procedure for the groupcast HARQ feedback option-1 (common NACK) involves NACK feedback received from the group member UEs in a common NACK feedback resource within the reference duration, where the reference duration corresponds to a channel occupancy initiated by a Tx UE including transmission of groupcast PSSCH (associated with a groupcast HARQ feedback option-1) as a duration starting from the beginning of the channel occupancy until the end of the first slot where at least one groupcast PSSCH (associated with a groupcast HARQ feedback option-1) is transmitted over the resources allocated for the groupcast PSSCH, or until the end of the first transmission burst by the Tx UE that contains groupcast PSSCH(s) (associated with a groupcast HARQ feedback option-1) transmitted over all the resources allocated for the groupcast PSSCH, whichever occurs earlier. If the channel occupancy includes a groupcast PSSCH (associated with a groupcast HARQ feedback option-1), but it does not include any groupcast PSSCH (associated with a groupcast HARQ feedback option-1) transmitted over all the resources allocated for that groupcast PSSCH, then, the duration of the first transmission burst by the UE within the channel occupancy that contains groupcast PSSCH(s) (associated with a groupcast HARQ feedback option-1) is the reference duration for CWS adjustment.

In one embodiment, for every channel access priority class pϵ{1,2,3,4} set CWp=CWmin,p, if a UE receives a PSFCH associated with a groupcast HARQ feedback option-1, and if the HARQ-ACK feedback value corresponding to groupcast PSSCH transmission within the reference duration is determined as ‘NACK’, increase the CWS for every priority class to the next higher allowed value or min (CWp×2+1, CWmax,p).

Otherwise, if a UE receives a PSFCH associated with a groupcast HARQ feedback option-1, and if the HARQ-ACK feedback value corresponding to groupcast PSSCH transmission within the reference duration is determined as ‘ACK’, then go to the first step above.

Otherwise, an absence of PSFCH reception for the PSFCH reception occasion for a PSSCH transmission is detected within the reference duration then it is considered as ‘ACK’ response and then CWS is set to CWmin,p.

In a second implementation, reference signal received power (“RSRP”) measurement from the PSFCH reception could be used as another metric to determine the CWS adjustment procedure where a threshold could be set based on at least one of the maximum number of UEs transmitting PSFCH (fulfilling minimum communication range (“MCR”), the communication range requirement) to the Tx UE that initiated the channel occupancy within the reference duration, the target received power parameter Po, and the fractional path-loss compensation parameter α. When the measured RSRP of received PSFCH is above the threshold then increase the CWS for every priority class to the next higher allowed value or min (CWp×2+1, CWmax,p). When the measured RSRP of received PSFCH is below the threshold then CWS is set to CWmin,p.

In a third implementation, CWS adjustment procedure for the groupcast HARQ feedback option-1 (common NACK) involve number of NACK feedback received from the group member UEs within the reference duration, where the reference duration corresponds to a channel occupancy initiated by a Tx UE including transmission of PSSCH as a duration starting from the beginning of the channel occupancy until at least HARQ-ACK feedback is expected from PSFCH reception for a number of slots where at least one groupcast PSSCH (associated with a groupcast HARQ feedback option-1) is transmitted over all the resources allocated for the groupcast PSSCH. In another example for a reference duration, corresponds to a channel occupancy initiated by a Tx UE including transmission of groupcast PSSCH (associated with a groupcast HARQ feedback option-1) as a duration starting from the beginning of the channel occupancy until at least HARQ-ACK feedback is expected from at least one PSFCH reception occasion from the number of PSFCH reception occasions in PSFCH resources associated with the groupcast PSSCH.

In one embodiment, for every channel access priority class pϵ{1,2,3,4} set CWp=CWmin,p, if the UE receives a PSFCH associated with a groupcast HARQ feedback option-1, and if at least Z=X % of HARQ-ACK feedback values (e.g., counting comprises 1 HARQ-ACK feedback value per PSFCH reception occasion) determined as ‘NACK’ corresponding to groupcast PSSCH transmission within the reference duration, or the RSRP threshold of the received PSFCH is above a pre-defined value for X % of the PSFCH reception occasions increase the CWS for every priority class to the next higher allowed value or min (CWp×2+1, CWmax,p).

Otherwise, an absence of PSFCH reception for the PSFCH reception occasion for a PSSCH transmission is detected within the reference duration then it is considered as ‘ACK’ response and if at least Z=Y % of HARQ-ACK feedback values determined as ‘ACK’ corresponding to groupcast PSSCH transmission within the reference duration, or the RSRP threshold of the received PSFCH is below a pre-defined value for Y % of the PSFCH reception occasions then CWS is set to CWmin,p (goto step 1 as described in the first bullet (step 1 as described in TS 37.213)). The value of Z=X % and/or Z=Y % could be configured per resource pool, per UE, per destination group, per carrier or fixed value specified in the standard.

In a third embodiment directed to blind retransmission and/or mixed retransmission containing both HARQ based and blind retransmission, if the channel occupancy includes a unicast or groupcast based PSSCH transmission but it does not include any HARQ feedback enabled PSSCH (e.g., HARQ enable bit is not set to ‘enable’ in the sidelink control information (“SCI”)) transmitted over all the resources allocated PSSCH, then the duration of the first transmission burst by the UE within the channel occupancy that is transmitted enabled with HARQ feedback PSSCH(s) is the reference duration for CWS adjustment.

For example, when the Tx UE decides to transmit a transport block (“TB”) using blind retransmission within the occupied channel, then the CWS adjustment remains same. In another example, when the Tx UE decides to transmit a TB using mixed of blind retransmission and HARQ feedback enabled transmission then the reference duration (accordingly the CWS) is set according to the first HARQ feedback enabled PSSCH transmission within the reference duration.

In one embodiment, the CWS adjustment for broadcast is always set to same when only broadcast based PSSCH is transmitted during the reference duration. However, the CWS adjustment depends on the duration of the first transmission burst by the UE within the channel occupancy that is transmitted enabled with HARQ feedback PSSCH(s) is the reference duration for CWS adjustment for any cast type.

In a fourth embodiment directed to UE to UE relay, the term eNB/gNB is used for the base station but it is replaceable by any other radio access node, e.g. BS, eNB, gNB, AP, NR etc. Further the proposed methods are described mainly in the context of 5G NR. However, the proposed solutions/methods are also equally applicable to other mobile communication systems supporting serving cells/carriers being configured for Sidelink Communication over PC5 interface.

The following terminology is used herein:
UE-to-network relay: N-relay
UE-to-UE relay: UE-relay
Relay=either of the above relays

Tx-Remote-UE (UE1) 302 is the UE that has some application data to be sent to another Remote UE shown as Rx-Remote-UE (UE3) 306 in FIG. 3, via a Relay (UE2) 304. At a different point in time, the UE3 306 may have data to send to UE1 302 via UE2 304 and in this context UE3 306 would take the role of a transmitter UE. There the terms and roles shown in FIG. 3, are with respect to a particular data packet only.

In the fourth embodiment, the Relay UE 304 could have multiple unicast connection using the first interface with one or more UE1 302 (Tx-Remote UE) and in the second interface with one or more Rx-Remote UE(s). The determination of the contention window size adjustment procedure for the Relay UE (UE2 304 in FIG. 3) could depend on the HARQ feedback received from one or more Rx Remote UE(s) in the second interface by reusing the procedures explained in the first and the second embodiment but those same procedure could also be equally applicable for the unicast PSSCH transmission happening in the second interface with one or more Rx-Remote UEs. These Rx-Remote UEs need not be part of the same destination id as described in the first and second embodiment. The transport block could have data multiplexed for multiple Rx-Remote UEs and in one example the determination of the contention window size adjustment depends on the HARQ feedback received from one or more Rx Remote UE belonging within the reference duration.

In another embodiment, the Tx Remote UE could have connection to multiple relay UE for transmitting the same TB or different TB belonging to the same destination id. In such case, the determination of the contention window size depends on the HARQ feedback received from one or more relay UEs configured to transmit data towards the same destination as explained in the first and second embodiment for all cast type.

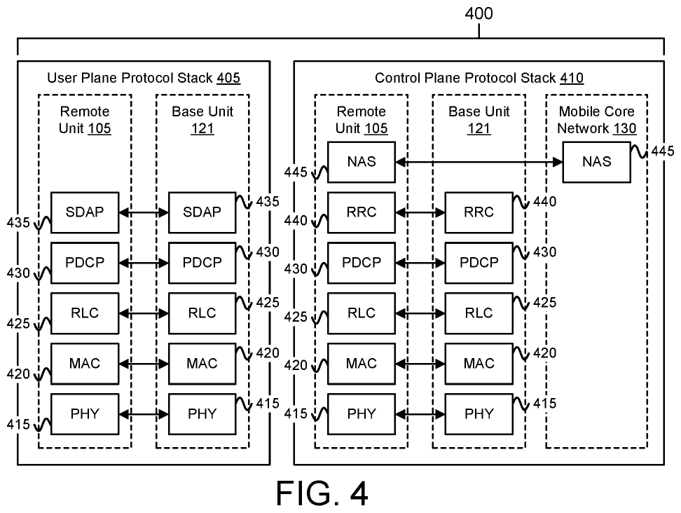

FIG. 4 depicts a NR protocol stack 400, according to embodiments of the disclosure. While FIG. 4 shows the remote unit 105, the base unit 121 and the mobile core network 130, these are representative of a set of UEs interacting with a RAN node and a NF (e.g., AMF) in a core network. As depicted, the protocol stack 400 comprises a User Plane protocol stack 405 and a Control Plane protocol stack 410. The User Plane protocol stack 405 includes a physical (“PHY”) layer 415, a Medium Access Control (“MAC”) sublayer 420, a Radio Link Control (“RLC”) sublayer 425, a Packet Data Convergence Protocol (“PDCP”) sublayer 430, and Service Data Adaptation Protocol (“SDAP”) layer 435. The Control Plane protocol stack 410 also includes a physical layer 415, a MAC sublayer 420, a RLC sublayer 425, and a PDCP sublayer 430. The Control Place protocol stack 410 also includes a Radio Resource Control (“RRC”) sublayer 440 and a Non-Access Stratum (“NAS”) layer 445.

The AS protocol stack for the Control Plane protocol stack 410 consists of at least RRC, PDCP, RLC and MAC sublayers, and the physical layer. The AS protocol stack for the User Plane protocol stack 405 consists of at least SDAP, PDCP, RLC and MAC sublayers, and the physical layer. The Layer-2 (“L2”) is split into the SDAP, PDCP, RLC and MAC sublayers. The Layer-3 (“L3”) includes the RRC sublayer 440 and the NAS layer 445 for the control plane and includes, e.g., an Internet Protocol (“IP”) layer or PDU Layer (note depicted) for the user plane. L1 and L2 are referred to as “lower layers” such as PUCCH/PUSCH or MAC CE, while L3 and above (e.g., transport layer, application layer) are referred to as “higher layers” or “upper layers” such as RRC.

The physical layer 415 offers transport channels to the MAC sublayer 420. The MAC sublayer 420 offers logical channels to the RLC sublayer 425. The RLC sublayer 425 offers RLC channels to the PDCP sublayer 430. The PDCP sublayer 430 offers radio bearers to the SDAP sublayer 435 and/or RRC layer 440. The SDAP sublayer 435 offers QoS flows to the mobile core network 130 (e.g., 5GC). The RRC layer 440 provides for the addition, modification, and release of Carrier Aggregation and/or Dual Connectivity. The RRC layer 440 also manages the establishment, configuration, maintenance, and release of Signaling Radio Bearers (“SRBs”) and Data Radio Bearers (“DRBs”). In certain embodiments, a RRC entity functions for detection of and recovery from radio link failure.

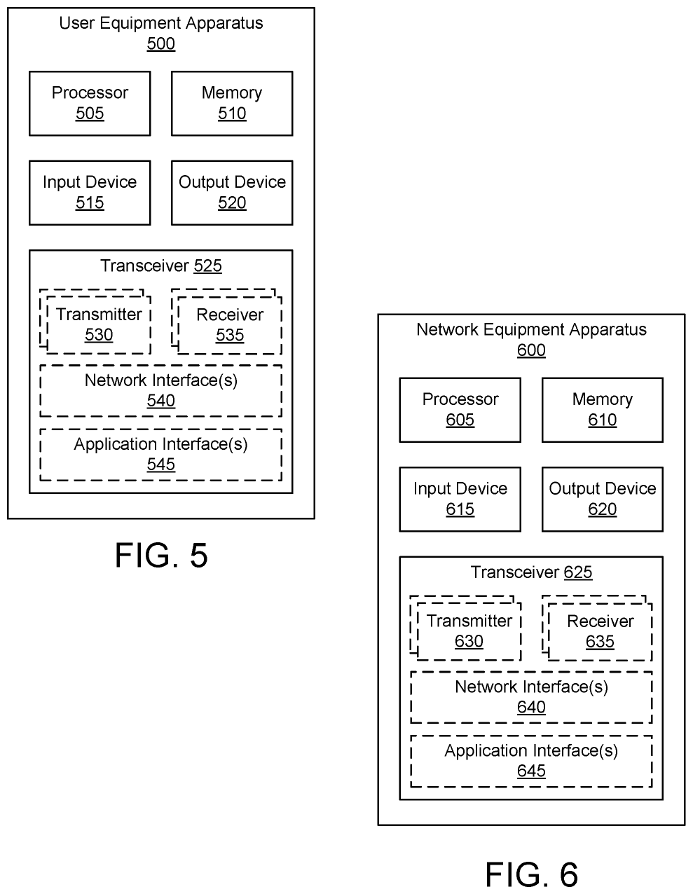

FIG. 5 depicts a user equipment apparatus 500 that may be used for contention window size adjustment procedure for sidelink groupcast, according to embodiments of the disclosure. In various embodiments, the user equipment apparatus 500 is used to implement one or more of the solutions described above. The user equipment apparatus 500 may be one embodiment of a UE, such as the remote unit 105 and/or the UE 205, as described above. Furthermore, the user equipment apparatus 500 may include a processor 505, a memory 510, an input device 515, an output device 520, and a transceiver 525. In some embodiments, the input device 515 and the output device 520 are combined into a single device, such as a touchscreen. In certain embodiments, the user equipment apparatus 500 may not include any input device 515 and/or output device 520. In various embodiments, the user equipment apparatus 500 may include one or more of: the processor 505, the memory 510, and the transceiver 525, and may not include the input device 515 and/or the output device 520.

As depicted, the transceiver 525 includes at least one transmitter 530 and at least one receiver 535. Here, the transceiver 525 communicates with one or more base units 121. Additionally, the transceiver 525 may support at least one network interface 540 and/or application interface 545. The application interface(s) 545 may support one or more APIs. The network interface(s) 540 may support 3GPP reference points, such as Uu and PC5. Other network interfaces 540 may be supported, as understood by one of ordinary skill in the art.

The processor 505, in one embodiment, may include any known controller capable of executing computer-readable instructions and/or capable of performing logical operations. For example, the processor 505 may be a microcontroller, a microprocessor, a central processing unit (“CPU”), a graphics processing unit (“GPU”), an auxiliary processing unit, a field programmable gate array (“FPGA”), a digital signal processor (“DSP”), a co-processor, an application-specific processor, or similar programmable controller. In some embodiments, the processor 505 executes instructions stored in the memory 510 to perform the methods and routines described herein. The processor 505 is communicatively coupled to the memory 510, the input device 515, the output device 520, and the transceiver 525. In certain embodiments, the processor 505 may include an application processor (also known as “main processor”) which manages application-domain and operating system (“OS”) functions and a baseband processor (also known as “baseband radio processor”) which manages radio functions.

The memory 510, in one embodiment, is a computer readable storage medium. In some embodiments, the memory 510 includes volatile computer storage media. For example, the memory 510 may include a RAM, including dynamic RAM (“DRAM”), synchronous dynamic RAM (“SDRAM”), and/or static RAM (“SRAM”). In some embodiments, the memory 510 includes non-volatile computer storage media. For example, the memory 510 may include a hard disk drive, a flash memory, or any other suitable non-volatile computer storage device. In some embodiments, the memory 510 includes both volatile and non-volatile computer storage media.

In some embodiments, the memory 510 stores data related to CSI enhancements for higher frequencies. For example, the memory 510 may store parameters, configurations, resource assignments, policies, and the like as described above. In certain embodiments, the memory 510 also stores program code and related data, such as an operating system or other controller algorithms operating on the user equipment apparatus 500, and one or more software applications.

The input device 515, in one embodiment, may include any known computer input device including a touch panel, a button, a keyboard, a stylus, a microphone, or the like. In some embodiments, the input device 515 may be integrated with the output device 520, for example, as a touchscreen or similar touch-sensitive display. In some embodiments, the input device 515 includes a touchscreen such that text may be input using a virtual keyboard displayed on the touchscreen and/or by handwriting on the touchscreen. In some embodiments, the input device 515 includes two or more different devices, such as a keyboard and a touch panel.

The output device 520, in one embodiment, is designed to output visual, audible, and/or haptic signals. In some embodiments, the output device 520 includes an electronically controllable display or display device capable of outputting visual data to a user. For example, the output device 520 may include, but is not limited to, an LCD display, an LED display, an OLED display, a projector, or similar display device capable of outputting images, text, or the like to a user. As another, non-limiting, example, the output device 520 may include a wearable display separate from, but communicatively coupled to, the rest of the user equipment apparatus 500, such as a smart watch, smart glasses, a heads-up display, or the like. Further, the output device 520 may be a component of a smart phone, a personal digital assistant, a television, a table computer, a notebook (laptop) computer, a personal computer, a vehicle dashboard, or the like.

In certain embodiments, the output device 520 includes one or more speakers for producing sound. For example, the output device 520 may produce an audible alert or notification (e.g., a beep or chime). In some embodiments, the output device 520 includes one or more haptic devices for producing vibrations, motion, or other haptic feedback. In some embodiments, all or portions of the output device 520 may be integrated with the input device 515. For example, the input device 515 and output device 520 may form a touchscreen or similar touch-sensitive display.

In other embodiments, the output device 520 may be located near the input device 515. The transceiver 525 includes at least transmitter 530 and at least one receiver 535. The transceiver 525 may be used to provide UL communication signals to a base unit 121 and to receive DL communication signals from the base unit 121, as described herein. Similarly, the transceiver 525 may be used to transmit and receive SL signals (e.g., V2X communication), as described herein. Although only one transmitter 530 and one receiver 535 are illustrated, the user equipment apparatus 500 may have any suitable number of transmitters 530 and receivers 535. Further, the transmitter(s) 530 and the receiver(s) 535 may be any suitable type of transmitters and receivers. In one embodiment, the transceiver 525 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 525, transmitters 530, and receivers 535 may be implemented as physically separate components that access a shared hardware resource and/or software resource, such as for example, the network interface 540.

In various embodiments, one or more transmitters 530 and/or one or more receivers 535 may be implemented and/or integrated into a single hardware component, such as a multi-transceiver chip, a system-on-a-chip, an ASIC, or other type of hardware component. In certain embodiments, one or more transmitters 530 and/or one or more receivers 535 may be implemented and/or integrated into a multi-chip module. In some embodiments, other components such as the network interface 540 or other hardware components/circuits may be integrated with any number of transmitters 530 and/or receivers 535 into a single chip. In such embodiment, the transmitters 530 and receivers 535 may be logically configured as a transceiver 525 that uses one more common control signals or as modular transmitters 530 and receivers 535 implemented in the same hardware chip or in a multi-chip module.

In one embodiment, the processor 505 transmits PSCCH and PSSCH corresponding to groupcast data transmission. In one embodiment, the processor 505 receives PSFCH containing HARQ feedback after a predetermined number of slots for a corresponding groupcast transmission. In one embodiment, the processor 505 determines a contention window size adjustment for a groupcast PSSCH based on the transmitted groupcast HARQ feedback associated with PSSCH within a reference duration.

In one embodiment, the processor 505 determines the contention window size adjustment of the apparatus transmitting groupcast PSSCH using HARQ feedback option 2 based on a percentage of ACK/NACK HARQ feedback received from one or more group member UE belonging to a same L2 destination ID.

In one embodiment, the processor 505 sets the contention window size for a priority class to a next higher allowed value or a calculated value min (CW×2+1, CWₘₐₓ), where CW is the contention window size, in response to at least Z=X % of HARQ-ACK values determined as ‘NACK’ from one or more group member UEs belonging to the same destination ID within the reference duration.

In one embodiment, the processor 505 sets the contention window size for the priority class to a minimum in response to at least Z=Y % of HARQ-ACK values determined as ‘ACK’ from one or more group member UEs belonging to the same destination ID within the reference duration.

In one embodiment, an absence of detecting PSFCH reception for a PSFCH reception occasion for a PSSCH transmission within the reference duration indicates an ‘NACK’ response.

In one embodiment, the processor 505 sets the contention window size to CW_{min,p} in response to detecting the absence of PSFCH reception for a PSFCH reception occasion for a PSSCH transmission within the reference duration.

In one embodiment, the value of Z=X % and/or Z=Y % of NACK and/or ACK respectively is configurable per resource pool, per UE, per destination group or carrier, or some combination thereof, or a fixed value.

In one embodiment, the processor 505 determines the contention window size adjustment of a transmitting UE transmitting groupcast PSSCH using HARQ feedback option 1 based on counting of number of NACKs received or based on no PSFCH feedback being detected from multiple PSFCH occasions corresponding to groupcast PSSCH.

In one embodiment, the reference duration corresponds to a channel occupancy initiated by a transmitting UE as a duration starting from a beginning of the channel occupancy until an end of a first slot where at least one groupcast PSSCH is transmitted over resources allocated for the groupcast PSSCH, or until an end of a first transmission burst by the transmitting UE that contains groupcast PSSCH transmitted over the resources allocated for the groupcast PSSCH.

In one embodiment, the processor 505 sets the contention window size for a priority class to a next higher allowed value or a calculated value min (CW×2+1, CWₘₐₓ), where CW is the contention window size, in response to number of NACKs received from multiple PSFCH occasions corresponding to groupcast PSSCH above a pre-defined value for X % of the PSFCH reception occasions.

In one embodiment, the processor 505 sets the contention window size to CW_{min,p} in response to detecting the absence of PSFCH reception for multiple PSFCH reception occasion for a PSSCH transmission within the reference duration.

In one embodiment, the reference duration corresponds to a channel occupancy initiated by a transmitting UE as a duration starting from a beginning of the channel occupancy until at least HARQ-ACK feedback is expected from at least one PSFCH reception occasion among a number of PSFCH reception occasions in PSFCH resources from one or more group member UEs belonging to a same L2 destination ID.

In one embodiment, the processor 505 maintains the contention window size adjustment constant in response to a transmitting UE transmitting a transport block using blind retransmission, broadcast, HARQ disabled transmission, or some combination thereof within an occupied channel.

In one embodiment, the processor 505 sets the reference duration according to a first HARQ feedback enabled PSSCH transmission within the reference duration in response to a transmitting UE transmitting a transport block using a mix of blind retransmission and HARQ feedback enabled transmission.

FIG. 6 depicts one embodiment of a network apparatus 600 that may be used for contention window size adjustment procedure for sidelink groupcast, according to embodiments of the disclosure. In some embodiments, the network apparatus 600 may be one embodiment of a RAN node and its supporting hardware, such as the base unit 121 and/or gNB, described above. Furthermore, network apparatus 600 may include a processor 605, a memory 610, an input device 615, an output device 620, and a transceiver 625. In certain embodiments, the network apparatus 600 does not include any input device 615 and/or output device 620.

As depicted, the transceiver 625 includes at least one transmitter 630 and at least one receiver 635. Here, the transceiver 625 communicates with one or more remote units 105. Additionally, the transceiver 625 may support at least one network interface 640 and/or application interface 645. The application interface(s) 645 may support one or more APIs. The network interface(s) 640 may support 3GPP reference points, such as Uu, N1, N2, N3, N5, N6 and/or N7 interfaces. Other network interfaces 640 may be supported, as understood by one of ordinary skill in the art.

When implementing an NEF the network interface(s) 640 may include an interface for communicating with an application function (i.e., N5) and with at least one network function (e.g., UDR, SFC function, UPF) in a mobile communication network, such as the mobile core network 130.

The processor 605, in one embodiment, may include any known controller capable of executing computer-readable instructions and/or capable of performing logical operations. For example, the processor 605 may be a microcontroller, a microprocessor, a CPU, a GPU, an auxiliary processing unit, a FPGA, a DSP, a co-processor, an application-specific processor, or similar programmable controller. In some embodiments, the processor 605 executes instructions stored in the memory 610 to perform the methods and routines described herein. The processor 605 is communicatively coupled to the memory 610, the input device 615, the output device 620, and the transceiver 625. In certain embodiments, the processor 605 may include an application processor (also known as “main processor”) which manages application-domain and OS functions and a baseband processor (also known as “baseband radio processor”) which manages radio function. In various embodiments, the processor 605 controls the network apparatus 600 to implement the above described network entity behaviors (e.g., of the gNB) for contention window size adjustment procedure for sidelink groupcast.

The memory 610, in one embodiment, is a computer readable storage medium. In some embodiments, the memory 610 includes volatile computer storage media. For example, the memory 610 may include a RAM, including DRAM, SDRAM, and/or SRAM. In some embodiments, the memory 610 includes non-volatile computer storage media. For example, the memory 610 may include a hard disk drive, a flash memory, or any other suitable non-volatile computer storage device. In some embodiments, the memory 610 includes both volatile and non-volatile computer storage media.

In some embodiments, the memory 610 stores data relating to CSI enhancements for higher frequencies. For example, the memory 610 may store parameters, configurations, resource assignments, policies, and the like as described above. In certain embodiments, the memory 610 also stores program code and related data, such as an OS or other controller algorithms operating on the network apparatus 600, and one or more software applications.

The input device 615, in one embodiment, may include any known computer input device including a touch panel, a button, a keyboard, a stylus, a microphone, or the like. In some embodiments, the input device 615 may be integrated with the output device 620, for example, as a touchscreen or similar touch-sensitive display. In some embodiments, the input device 615 includes a touchscreen such that text may be input using a virtual keyboard displayed on the touchscreen and/or by handwriting on the touchscreen. In some embodiments, the input device 615 includes two or more different devices, such as a keyboard and a touch panel.

The output device 620, in one embodiment, may include any known electronically controllable display or display device. The output device 620 may be designed to output visual, audible, and/or haptic signals. In some embodiments, the output device 620 includes an electronic display capable of outputting visual data to a user. Further, the output device 620 may be a component of a smart phone, a personal digital assistant, a television, a table computer, a notebook (laptop) computer, a personal computer, a vehicle dashboard, or the like.

In certain embodiments, the output device 620 includes one or more speakers for producing sound. For example, the output device 620 may produce an audible alert or notification (e.g., a beep or chime). In some embodiments, the output device 620 includes one or more haptic devices for producing vibrations, motion, or other haptic feedback. In some embodiments, all or portions of the output device 620 may be integrated with the input device 615. For example, the input device 615 and output device 620 may form a touchscreen or similar touch-sensitive display. In other embodiments, all or portions of the output device 620 may be located near the input device 615.

As discussed above, the transceiver 625 may communicate with one or more remote units and/or with one or more interworking functions that provide access to one or more PLMNs. The transceiver 625 may also communicate with one or more network functions (e.g., in the mobile core network 80). The transceiver 625 operates under the control of the processor 605 to transmit messages, data, and other signals and also to receive messages, data, and other signals. For example, the processor 605 may selectively activate the transceiver (or portions thereof) at particular times in order to send and receive messages.

The transceiver 625 may include one or more transmitters 630 and one or more receivers 635. In certain embodiments, the one or more transmitters 630 and/or the one or more receivers 635 may share transceiver hardware and/or circuitry. For example, the one or more transmitters 630 and/or the one or more receivers 635 may share antenna(s), antenna tuner(s), amplifier(s), filter(s), oscillator(s), mixer(s), modulator/demodulator(s), power supply, and the like. In one embodiment, the transceiver 625 implements multiple logical transceivers using different communication protocols or protocol stacks, while using common physical hardware.

In one embodiment, the processor 605 receives PSCCH and PSSCH corresponding to groupcast data transmission. In one embodiment, the processor 605 transmits PSFCH containing HARQ feedback after a predetermined number of slots for a corresponding groupcast transmission for determining a contention window size adjustment for a groupcast PSSCH based on the transmitted groupcast HARQ feedback associated with PSSCH within a reference duration.

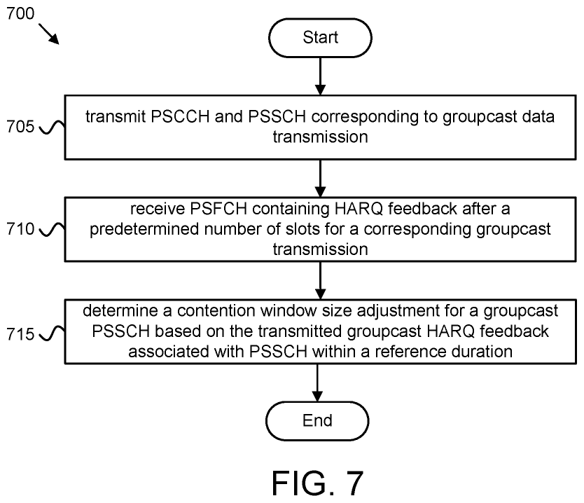

FIG. 7 is a flowchart diagram of a method 700 for contention window size adjustment procedure for sidelink groupcast. The method 700 may be performed by a UE as described herein, for example, the remote unit 105 and/or the user equipment apparatus 500. In some embodiments, the method 700 may be performed by a processor executing program code, for example, a microcontroller, a microprocessor, a CPU, a GPU, an auxiliary processing unit, a FPGA, or the like.

In one embodiment, the method 700 begins and transmits 705 PSCCH and PSSCH corresponding to groupcast data transmission. In one embodiment, the method 700 receives 710 PSFCH containing HARQ feedback after a predetermined number of slots for a corresponding groupcast transmission. In one embodiment, the method 700 determines 715 a contention window size adjustment for a groupcast PSSCH based on the transmitted groupcast HARQ feedback associated with PSSCH within a reference duration, and the method 700 ends.

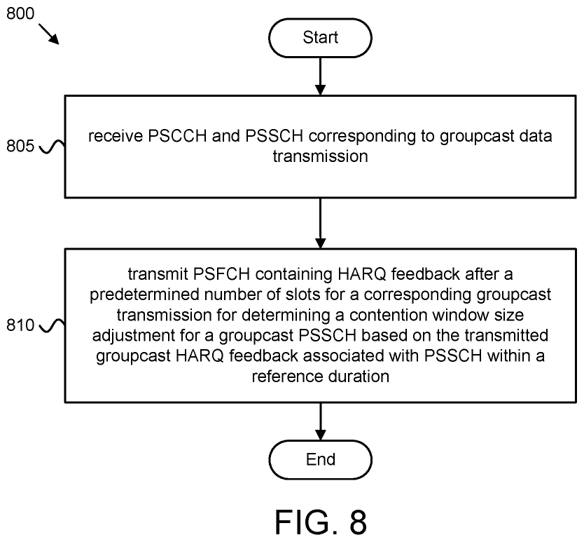

FIG. 8 is a flowchart diagram of a method 800 for contention window size adjustment procedure for sidelink groupcast. The method 800 may be performed by a network device as described herein, for example, the base unit 121, gNB, and/or the network equipment apparatus 600. In some embodiments, the method 800 may be performed by a processor executing program code, for example, a microcontroller, a microprocessor, a CPU, a GPU, an auxiliary processing unit, a FPGA, or the like.

In one embodiment, the method 800 begins and receives 805 PSCCH and PSSCH corresponding to groupcast data transmission. In one embodiment, the method 800 transmits 810 PSFCH containing HARQ feedback after a predetermined number of slots for a corresponding groupcast transmission for determining a contention window size adjustment for a groupcast PSSCH based on the transmitted groupcast HARQ feedback associated with PSSCH within a reference duration, and the method 800 ends.

A first apparatus is disclosed for contention window size adjustment procedure for sidelink groupcast. The first apparatus may include a UE as described herein, for example, the remote unit 105 and/or the user equipment apparatus 500. In some embodiments, the first apparatus includes a processor executing program code, for example, a microcontroller, a microprocessor, a CPU, a GPU, an auxiliary processing unit, a FPGA, or the like.

In one embodiment, the first apparatus includes a processor and a memory coupled to the processor. In one embodiment, the processor is configured to cause the apparatus to transmit PSCCH and PSSCH corresponding to groupcast data transmission. In one embodiment, the processor is configured to cause the apparatus to receive PSFCH containing HARQ feedback after a predetermined number of slots for a corresponding groupcast transmission. In one embodiment, the processor is configured to cause the apparatus to determine a contention window size adjustment for a groupcast PSSCH based on the transmitted groupcast HARQ feedback associated with PSSCH within a reference duration.

In one embodiment, the processor is configured to determine the contention window size adjustment of the apparatus transmitting groupcast PSSCH using HARQ feedback option 2 based on a percentage of ACK/NACK HARQ feedback received from one or more group member UE belonging to a same L2 destination ID.

In one embodiment, the processor is configured to set the contention window size for a priority class to a next higher allowed value or a calculated value min (CW×2+1, CWₘₐₓ), where CW is the contention window size, in response to at least Z=X % of HARQ-ACK values determined as ‘NACK’ from one or more group member UEs belonging to the same destination ID within the reference duration.

In one embodiment, the processor is configured to set the contention window size for the priority class to a minimum in response to at least Z=Y % of HARQ-ACK values determined as ‘ACK’ from one or more group member UEs belonging to the same destination ID within the reference duration.

In one embodiment, an absence of detecting PSFCH reception for a PSFCH reception occasion for a PSSCH transmission within the reference duration indicates an ‘NACK’ response.

In one embodiment, the processor is configured to set the contention window size to CW_{min,p} in response to detecting the absence of PSFCH reception for a PSFCH reception occasion for a PSSCH transmission within the reference duration.

In one embodiment, the value of Z=X % and/or Z=Y % of NACK and/or ACK respectively is configurable per resource pool, per UE, per destination group or carrier, or some combination thereof, or a fixed value.

In one embodiment, the processor is configured to determine the contention window size adjustment of a transmitting UE transmitting groupcast PSSCH using HARQ feedback option 1 based on counting of number of NACKs received or based on no PSFCH feedback being detected from multiple PSFCH occasions corresponding to groupcast PSSCH.

In one embodiment, the reference duration corresponds to a channel occupancy initiated by a transmitting UE as a duration starting from a beginning of the channel occupancy until an end of a first slot where at least one groupcast PSSCH is transmitted over resources allocated for the groupcast PSSCH, or until an end of a first transmission burst by the transmitting UE that contains groupcast PSSCH transmitted over the resources allocated for the groupcast PSSCH.

In one embodiment, the processor is configured to set the contention window size for a priority class to a next higher allowed value or a calculated value min (CW×2+1, CWₘₐₓ), where CW is the contention window size, in response to number of NACKs received from multiple PSFCH occasions corresponding to groupcast PSSCH above a pre-defined value for X % of the PSFCH reception occasions.

In one embodiment, the processor is configured to set the contention window size to CW_{min,p} in response to detecting the absence of PSFCH reception for multiple PSFCH reception occasion for a PSSCH transmission within the reference duration.

In one embodiment, the reference duration corresponds to a channel occupancy initiated by a transmitting UE as a duration starting from a beginning of the channel occupancy until at least HARQ-ACK feedback is expected from at least one PSFCH reception occasion among a number of PSFCH reception occasions in PSFCH resources from one or more group member UEs belonging to a same L2 destination ID.

In one embodiment, the processor is configured to maintain the contention window size adjustment constant in response to a transmitting UE transmitting a transport block using blind retransmission, broadcast, HARQ disabled transmission, or some combination thereof within an occupied channel.

In one embodiment, the processor is configured to set the reference duration according to a first HARQ feedback enabled PSSCH transmission within the reference duration in response to a transmitting UE transmitting a transport block using a mix of blind retransmission and HARQ feedback enabled transmission.

A first method is disclosed for contention window size adjustment procedure for sidelink groupcast. The first method may be performed by a UE as described herein, for example, the remote unit 105 and/or the user equipment apparatus 500. In some embodiments, the first method may be performed by a processor executing program code, for example, a microcontroller, a microprocessor, a CPU, a GPU, an auxiliary processing unit, a FPGA, or the like.

In one embodiment, the first method transmits PSCCH and PSSCH corresponding to groupcast data transmission. In one embodiment, the first method receives PSFCH containing HARQ feedback after a predetermined number of slots for a corresponding groupcast transmission. In one embodiment, the first method determines a contention window size adjustment for a groupcast PSSCH based on the transmitted groupcast HARQ feedback associated with PSSCH within a reference duration.

In one embodiment, the first method determines the contention window size adjustment of the apparatus transmitting groupcast PSSCH using HARQ feedback option 2 based on a percentage of ACK/NACK HARQ feedback received from one or more group member UE belonging to a same L2 destination ID.

In one embodiment, the first method sets the contention window size for a priority class to a next higher allowed value or a calculated value min (CW×2+1, CWₘₐₓ), where CW is the contention window size, in response to at least Z=X % of HARQ-ACK values determined as ‘NACK’ from one or more group member UEs belonging to the same destination ID within the reference duration.

In one embodiment, the first method sets the contention window size for the priority class to a minimum in response to at least Z=Y % of HARQ-ACK values determined as ‘ACK’ from one or more group member UEs belonging to the same destination ID within the reference duration.

In one embodiment, an absence of detecting PSFCH reception for a PSFCH reception occasion for a PSSCH transmission within the reference duration indicates an ‘NACK’ response.

In one embodiment, the first method sets the contention window size to CW_{min,p} in response to detecting the absence of PSFCH reception for a PSFCH reception occasion for a PSSCH transmission within the reference duration.

In one embodiment, the value of Z=X % and/or Z=Y % of NACK and/or ACK respectively is configurable per resource pool, per UE, per destination group or carrier, or some combination thereof, or a fixed value.

In one embodiment, the first method determines the contention window size adjustment of a transmitting UE transmitting groupcast PSSCH using HARQ feedback option 1 based on counting of number of NACKs received or based on no PSFCH feedback being detected from multiple PSFCH occasions corresponding to groupcast PSSCH.

In one embodiment, the reference duration corresponds to a channel occupancy initiated by a transmitting UE as a duration starting from a beginning of the channel occupancy until an end of a first slot where at least one groupcast PSSCH is transmitted over resources allocated for the groupcast PSSCH, or until an end of a first transmission burst by the transmitting UE that contains groupcast PSSCH transmitted over the resources allocated for the groupcast PSSCH.

In one embodiment, the first method sets the contention window size for a priority class to a next higher allowed value or a calculated value min (CW×2+1, CWₘₐₓ), where CW is the contention window size, in response to number of NACKs received from multiple PSFCH occasions corresponding to groupcast PSSCH above a pre-defined value for X % of the PSFCH reception occasions.

In one embodiment, the first method sets the contention window size to CW_{min,p} in response to detecting the absence of PSFCH reception for multiple PSFCH reception occasion for a PSSCH transmission within the reference duration.

In one embodiment, the reference duration corresponds to a channel occupancy initiated by a transmitting UE as a duration starting from a beginning of the channel occupancy until at least HARQ-ACK feedback is expected from at least one PSFCH reception occasion among a number of PSFCH reception occasions in PSFCH resources from one or more group member UEs belonging to a same L2 destination ID.

In one embodiment, the first method maintains the contention window size adjustment constant in response to a transmitting UE transmitting a transport block using blind retransmission, broadcast, HARQ disabled transmission, or some combination thereof within an occupied channel.

In one embodiment, the first method sets the reference duration according to a first HARQ feedback enabled PSSCH transmission within the reference duration in response to a transmitting UE transmitting a transport block using a mix of blind retransmission and HARQ feedback enabled transmission.

A second apparatus is disclosed for contention window size adjustment procedure for sidelink groupcast. The second apparatus may include a network device as described herein, for example, the base unit 121, gNB, and/or the network equipment apparatus 600. In some embodiments, the second apparatus may include a processor executing program code, for example, a microcontroller, a microprocessor, a CPU, a GPU, an auxiliary processing unit, a FPGA, or the like.

In one embodiment, the second apparatus includes a processor and a memory coupled to the processor. In one embodiment, the processor is configured to cause the apparatus to receive PSCCH and PSSCH corresponding to groupcast data transmission. In one embodiment, the processor is configured to cause the apparatus to transmit PSFCH containing HARQ feedback after a predetermined number of slots for a corresponding groupcast transmission for determining a contention window size adjustment for a groupcast PSSCH based on the transmitted groupcast HARQ feedback associated with PSSCH within a reference duration.

A second method is disclosed for contention window size adjustment procedure for sidelink groupcast. The second method may be performed by a network device as described herein, for example, the base unit 121, gNB, and/or the network equipment apparatus 600. In some embodiments, the second method may be performed by a processor executing program code, for example, a microcontroller, a microprocessor, a CPU, a GPU, an auxiliary processing unit, a FPGA, or the like.

In one embodiment, the second method receives PSCCH and PSSCH corresponding to groupcast data transmission. In one embodiment, the second method transmits PSFCH containing HARQ feedback after a predetermined number of slots for a corresponding groupcast transmission for determining a contention window size adjustment for a groupcast PSSCH based on the transmitted groupcast HARQ feedback associated with PSSCH within a reference duration.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus, comprising:
a processor; and
a memory coupled to the processor, the processor configured to cause the apparatus to:
transmit physical shared control channel (“PSCCH”) and physical shared sidelink channel (“PSSCH”) corresponding to groupcast data transmission;
receive physical shared feedback channel (“PSFCH”) containing hybrid automatic repeat request (“HARQ”) feedback after a predetermined number of slots for a corresponding groupcast transmission; and
determine a contention window size adjustment for a groupcast PSSCH based on the transmitted groupcast HARQ feedback associated with PSSCH within a reference duration.

2. The apparatus of claim 1, wherein the processor is configured to determine the contention window size adjustment of the apparatus transmitting groupcast PSSCH using HARQ feedback option 2 based on a percentage of acknowledgement (“ACK”)/negative ACK (“NACK”) HARQ feedback received from one or more group member user equipment (“UE”) belonging to a same L2 destination ID.

3. The apparatus of claim 2, wherein the processor is configured to set the contention window size for a priority class to a next higher allowed value or a calculated value min (CW×2+1, CWₘₐₓ), where CW is the contention window size, in response to at least Z=X % of HARQ-ACK values determined as ‘NACK’ from one or more group member UEs belonging to the same destination ID within the reference duration.

4. The apparatus of claim 3, wherein the processor is configured to set the contention window size for the priority class to a minimum in response to at least Z=Y % of HARQ-ACK values determined as ‘ACK’ from one or more group member UEs belonging to the same destination ID within the reference duration.

5. The apparatus of claim 4, wherein an absence of detecting PSFCH reception for a PSFCH reception occasion for a PSSCH transmission within the reference duration indicates an ‘NACK’ response.

6. The apparatus of claim 4, wherein the value of Z=X % and/or Z=Y % of NACK and/or ACK respectively is configurable per resource pool, per UE, per destination group or carrier, or some combination thereof, or a fixed value.

7. The apparatus of claim 3, wherein the processor is configured to determine the contention window size adjustment of a transmitting UE transmitting groupcast PSSCH using HARQ feedback option 1 based on counting of number of NACKs received or based on no PSFCH feedback being detected from multiple PSFCH occasions corresponding to groupcast PSSCH.

8. The apparatus of claim 2, wherein the reference duration corresponds to a channel occupancy initiated by a transmitting UE as a duration starting from a beginning of the channel occupancy until an end of a first slot where at least one groupcast PSSCH is transmitted over resources allocated for the groupcast PSSCH, or until an end of a first transmission burst by the transmitting UE that contains groupcast PSSCH transmitted over the resources allocated for the groupcast PSSCH.

9. The apparatus of claim 8, wherein the processor is configured to set the contention window size for a priority class to a next higher allowed value or a calculated value min (CW×2+1, CWₘₐₓ), where CW is the contention window size, in response to number of NACKs received from multiple PSFCH occasions corresponding to groupcast PSSCH above a pre-defined value for X % of the PSFCH reception occasions.

10. The apparatus of claim 8, wherein the processor is configured to set the contention window size to CW_{min,p} in response to detecting the absence of PSFCH reception for multiple PSFCH reception occasion for a PSSCH transmission within the reference duration.

11. The apparatus of claim 2, wherein the reference duration corresponds to a channel occupancy initiated by a transmitting UE as a duration starting from a beginning of the channel occupancy until at least HARQ-ACK feedback is expected from at least one PSFCH reception occasion among a number of PSFCH reception occasions in PSFCH resources from one or more group member UEs belonging to a same L2 destination ID.

12. The apparatus of claim 1, wherein the processor is configured to maintain the contention window size adjustment constant in response to a transmitting user equipment (“UE”) transmitting a transport block using blind retransmission, broadcast, HARQ disabled transmission, or some combination thereof within an occupied channel.

13. The apparatus of claim 1, wherein the processor is configured to set the reference duration according to a first HARQ feedback enabled PSSCH transmission within the reference duration in response to a transmitting user equipment (“UE”) transmitting a transport block using a mix of blind retransmission and HARQ feedback enabled transmission.

14. A method, comprising:
transmitting physical shared control channel (“PSCCH”) and physical shared sidelink channel (“PSSCH”) corresponding to groupcast data transmission;
receiving physical shared feedback channel (“PSFCH”) containing hybrid automatic repeat request (“HARQ”) feedback after a predetermined number of slots for a corresponding groupcast transmission; and
determining a contention window size adjustment for a groupcast PSSCH based on the transmitted groupcast HARQ feedback associated with PSSCH within a reference duration.

15. An apparatus, comprising:
a processor; and
a memory coupled to the processor, the processor configured to cause the apparatus to:
receive physical shared control channel (“PSCCH”) and physical shared sidelink channel (“PSSCH”) corresponding to groupcast data transmission; and
transmit physical shared feedback channel (“PSFCH”) containing hybrid automatic repeat request (“HARQ”) feedback after a predetermined number of slots for a corresponding groupcast transmission for determining a contention window size adjustment for a groupcast PSSCH based on the transmitted groupcast HARQ feedback associated with PSSCH within a reference duration.
